(19) United States
(12) Patent Application Publication
(10) Pub. No.: US 2010/0217437 A1
(43) Pub. Date: Aug. 26, 2010

(54) AUTONOMOUS ROBOTIC ASSEMBLY SYSTEM

(76) Inventors: Branko Sarh, Huntington Beach, CA (US); David H. Amirebteshami, Rossmoor, CA (US)

Correspondence Address: DUKE W. YEE, YEE & ASSOCIATES, P.C., P.O. BOX 802333, DALLAS, TX, 75380, US

(21) Appl. No.: 12/391,780

(22) Filed: Feb. 24, 2009

(51) Int. Cl. G05B 19/418

(52) U.S. Cl. 700/248

(57) ABSTRACT

An apparatus comprises a plurality of mobile robotic machines, a wireless communications system, and a motion control system. The plurality of mobile robotic machines may be capable of moving to a number of locations in an assembly area and performing operations to assemble a structure in the assembly area. The wireless communications system may be capable of providing communications with the plurality of mobile robotic machines within the assembly area. The motion control system may be capable of generating position information for the plurality of mobile robotic machines in the assembly area and communicating the position.

### BACKGROUND INFORMATION

1. Field

The present disclosure relates generally to manufacturing objects and, in particular, to an automated system for assembling objects. Still more particularly, the present disclosure relates to a method and apparatus for assembling aircraft structures using an autonomous robotic assembly system.

2. Background

Assembly of structures may involve the use of machines, tools, human labor, materials, and/or other suitable items for creating objects. Various assembly line techniques may be used to manufacture objects, such as aircraft structures. With an assembly line, various stationary machines may be positioned along the assembly line to add a part, drill a hole, hold a part, and/or perform some other suitable operation during the assembly of an aircraft structure.

With this type of assembly system, each assembly line may be designed for a particular type of aircraft structure. For example, without limitation, one assembly line may be designed to manufacture aircraft wings, while another assembly line may be designed to manufacture fuselages.

For a particular type of structure, machines may be secured to the floor or may be moveable along rails installed onto the floor and/or in trenches in the floor. Further, with this type of assembly system, conduits, trenches, and/or other suitable structures may be used to run power cables, data lines, and/or other suitable utilities to these machines.

Although these types of assembly lines may provide for decreased cost with economies of scale, these types of assembly systems may be expensive to design and install. For example, although an assembly line may be adaptable to assemble a wing structure for different types of commercial aircraft having a similar size, a separate assembly line may be required to manufacture fuselages. With this limited flexibility, increased space may be required to assemble different types of aircraft structures.

Therefore, it would be advantageous to have a method and apparatus that takes into account one or more of the issues discussed above, as well as possibly other issues.

### SUMMARY

In one advantageous embodiment, an apparatus may comprise a plurality of mobile robotic machines, a wireless communications system, and a motion control system. The plurality of mobile robotic machines may be capable of moving to a number of locations in an assembly area and may be capable of performing operations to assemble a structure in the assembly area. The wireless communications system may be capable of providing communications with the plurality of mobile robotic machines within the assembly area. The motion control system may be capable of generating position information for the plurality of mobile robotic machines in the assembly area and communicating the position information to the plurality of mobile robotic machines.

In another advantageous embodiment, an assembly system may comprise an external mobile robotic machine and an internal mobile robotic machine. The external mobile robotic machine may be capable of moving around an exterior of a structure and may be capable of performing a number of first operations on the exterior of the structure. The internal mobile robotic machine may be capable of performing a number of second operations in an interior of the structure. The internal mobile robotic machine may also be capable of performing the number of second operations in conjunction with the number of first operations performed by the external mobile robotic machine to assemble the structure.

In yet another advantageous embodiment, an aircraft assembly system may comprise a plurality of mobile robotic machines, a number of racks, a wireless communications system, a motion control system, and a computer system. The plurality of mobile robotic machines may be capable of moving to a number of locations in an assembly area and performing operations to assemble a structure for an aircraft in the assembly area. The plurality of mobile robotic machines may comprise at least one of an internal mobile robotic machine, an external mobile robotic machine, a flexible fixture, and a servicing machine. The external mobile robotic machine may be capable of moving around an exterior of the structure and performing a number of first operations on the exterior of the structure. The internal mobile robotic machine may be capable of performing a number of second operations in an interior of the structure. The internal mobile robotic machine may also be capable of performing the number of second operations in conjunction with the number of first operations performed by the external mobile robotic machine. The number of racks may be capable of carrying supplies for the plurality of mobile robotic machines. The supplies may comprise at least one of a power unit, an end effector, a tool, and a part. The wireless communications system may be capable of providing communications with the plurality of mobile robotic machines within the assembly area. The wireless communications system may comprise a number of wireless ports located in the assembly area. Each of the plurality of mobile robotic machines may have a communications unit capable of establishing a communications link with the number of wireless ports. The motion control system may be capable of generating position information for the plurality of mobile robotic machines in the assembly area and communicating the position information to the plurality of mobile robotic machines. The motion control system may comprise a plurality of sensors and a computer capable of identifying positions of the plurality of mobile robotic machines using the plurality of sensors. The plurality of sensors may comprise a number of types of sensors selected from at least one of a camera, a receiver capable of receiving global positioning system information from the plurality of mobile robotic machines, and a radio frequency identification sensor reader. The plurality of sensors may be located on at least one of the plurality of mobile robotic machines and at selected locations in the assembly area. The position information may comprise at least one of a position for an arm on a mobile robotic machine, a position of an end effector on the mobile robotic machine, a position of a body of the mobile robotic machine, and a position of a part. The computer system may be capable of exchanging information with the plurality of mobile robotic machines. The information may comprise at least one of a command, data, position of a mobile robotic machine, and a program capable of being executed by a mobile robotic machine in the plurality of mobile robotic machines.

In still yet another advantageous embodiment, a method may be present for assembling a structure. Communications with a plurality of mobile robotic machines may be capable of moving to a number of locations in an assembly area and may be capable of performing operations to assemble the structure in the assembly area may be established using a wireless communications system. Position information for the plurality of mobile robotic machines may be identified using a motion control system. Information may be sent to the plurality of mobile robotic machines. The information may comprise the position information. Operations may be performed to assemble the structure using the position information.

In still another advantageous embodiment, a method is present for assembling an aircraft structure. Communications may be established with a plurality of mobile robotic machines capable of moving to a number of locations in an assembly area and capable of performing operations to assemble the aircraft structure in the assembly area using a wireless communications system. Position information for the plurality of mobile robotic machines may be identified using a motion control system. Information may be sent to the plurality of mobile robotic machines. The information comprises at least one of the position information and a number of programs and commands. Messages may be communicated between the plurality of mobile robotic machines. The operations to assemble the aircraft structure may be performed using the information and the messages.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of an aircraft manufacturing and service method in accordance with an advantageous embodiment;

FIG. 2 is an illustration of an aircraft in which an advantageous embodiment may be implemented;

FIG. 3 is an illustration of an assembly environment in accordance with an advantageous embodiment;

FIG. 4 is an illustration of an assembly process in accordance with an advantageous embodiment;

FIG. 5 is an illustration of a data processing system in accordance with an advantageous embodiment;

FIG. 6 is an illustration of a mobile robotic machine in accordance with an advantageous embodiment;

FIG. 7 is an illustration of an assembly environment in accordance with an advantageous embodiment;

FIG. 8 is an illustration of an assembly environment in accordance with an advantageous embodiment;

FIG. 9 is an illustration of an assembly area in accordance with an advantageous embodiment;

FIG. 10 is an illustration of a flowchart of a process for assembling a structure in accordance with an advantageous embodiment;

FIG. 11 is an illustration of a flowchart of a process for assembling a structure in accordance with an advantageous embodiment;

FIG. 12 is an illustration of a flowchart of a process for assembling a structure in accordance with an advantageous embodiment;

FIGS. 13A-13D are an illustration of a flowchart of a process for assembling an aircraft structure in accordance with an advantageous embodiment; and

FIG. 14 is an illustration of a flowchart of a process for performing operations on a structure in accordance with an advantageous embodiment.

### DETAILED DESCRIPTION

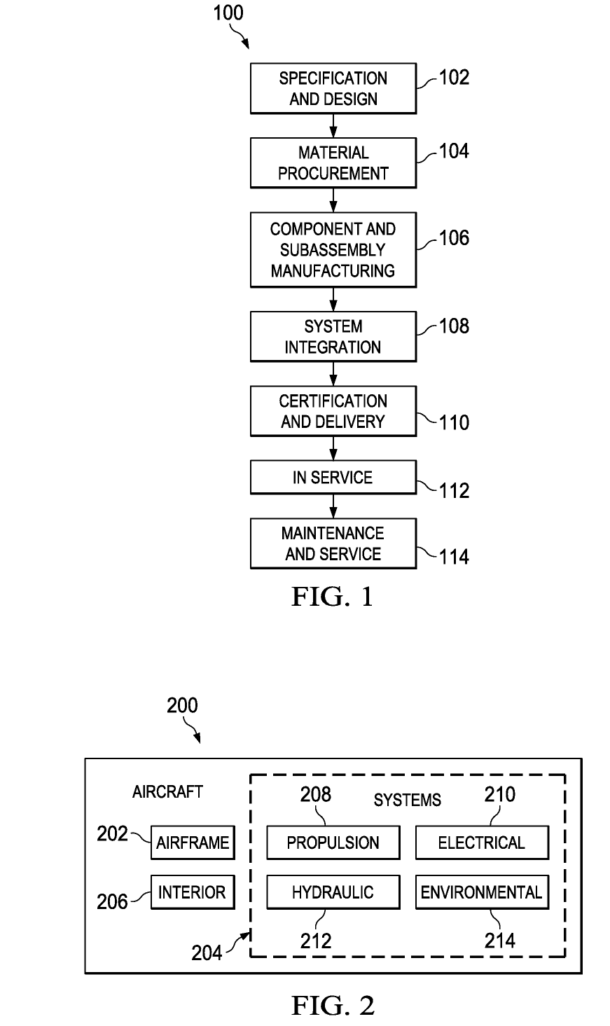

Referring more particularly to the drawings, embodiments of the disclosure may be described in the context of aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 may be scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during any one or more of the stages of aircraft manufacturing and service method 100 in FIG. 1. For example, components or subassemblies produced in component and subassembly manufacturing 106 in FIG. 1 may be fabricated or manufactured in a manner similar to components or subassemblies produced while aircraft 200 is in service 112 in FIG. 1.

Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1.

The different advantageous embodiments take into account and recognize that although currently used manufacturing techniques may reduce the costs of manufacturing objects, such as aircraft structures, these techniques may be difficult to implement. The different advantageous embodiments recognize and take into account that a different assembly system may be required for different types of aircraft structures.

For example, the different advantageous embodiments recognize and take into account that an aircraft assembly system designed for manufacturing aircraft wings may not be suitable for use in manufacturing aircraft fuselages. The different advantageous embodiments recognize and take into account that the manufacturing floor may be specifically designed for a particular type of structure.

The different advantageous embodiments recognize and take into account that a different type of aircraft structure may require a different layout for which the existing layout cannot be modified. The different advantageous embodiments recognize and take into account that stationary machines may be difficult to move, replace, and/or remount in different locations for different types of aircraft structures. The different advantageous embodiments recognize and take into account that although this type of change may be made, the change may be time consuming and expensive.

The different advantageous embodiments also recognize and take into account that the trenches and conduits in the manufacturing floor may be even more difficult to change and/or reroute. The time and expense needed to reroute power lines, data lines, and/or other utilities may require creating new trenches and/or conduits in the ground of the manufacturing area. The different advantageous embodiments recognize and take into account that this type of change, along with removing and remounting stationary machines to new locations, may be expensive.

In addition, the different advantageous embodiments recognize and take into account that in addition to the expense, the time needed to make these changes may make the manufacturing facility unavailable during that period of time. As a result, the different advantageous embodiments recognize and take into account that manufacturing times may increase and/or may cause delays in delivering products.

Thus, one or more of the advantageous embodiments may provide an apparatus that comprises a plurality of mobile robotic machines, a wireless communications system, and a motion control system. The plurality of mobile robotic machines may be capable of moving to a number of locations in an assembly area and may be capable of performing operations to assemble a structure in the assembly area. A number, as used herein, refers to one or more items. For example, a number of locations may be one or more locations.

The wireless communications system may be capable of providing communications with the plurality of mobile robotic machines within the assembly area. The motion control system may be capable of generating position information for the plurality of mobile robotic machines in the assembly area and communicating the position information to the plurality of mobile robotic machines.

As a specific illustrative example, one or more of the different advantageous embodiments may be implemented during component and subassembly manufacturing 106 to assemble a structure for aircraft 200. For example, the different advantageous embodiments may be used to assemble at least one of a wing, a fuselage, or some other suitable structure. As used herein, the phrase “at least one of”, when used with a list of items, means that different combinations of one or more of the items may be used and only one of each item in the list may be needed. For example, “at least one of item A, item B, and item C” may include, for example, without limitation, item A or item A and item B. This example also may include item A, item B, and item C or item B and item C.

Further, the different advantageous embodiments also may be used during maintenance and service 114 to assemble replacement structures, perform maintenance on existing structures, perform repairs on existing structures, and/or other suitable operations for structures in aircraft 200.

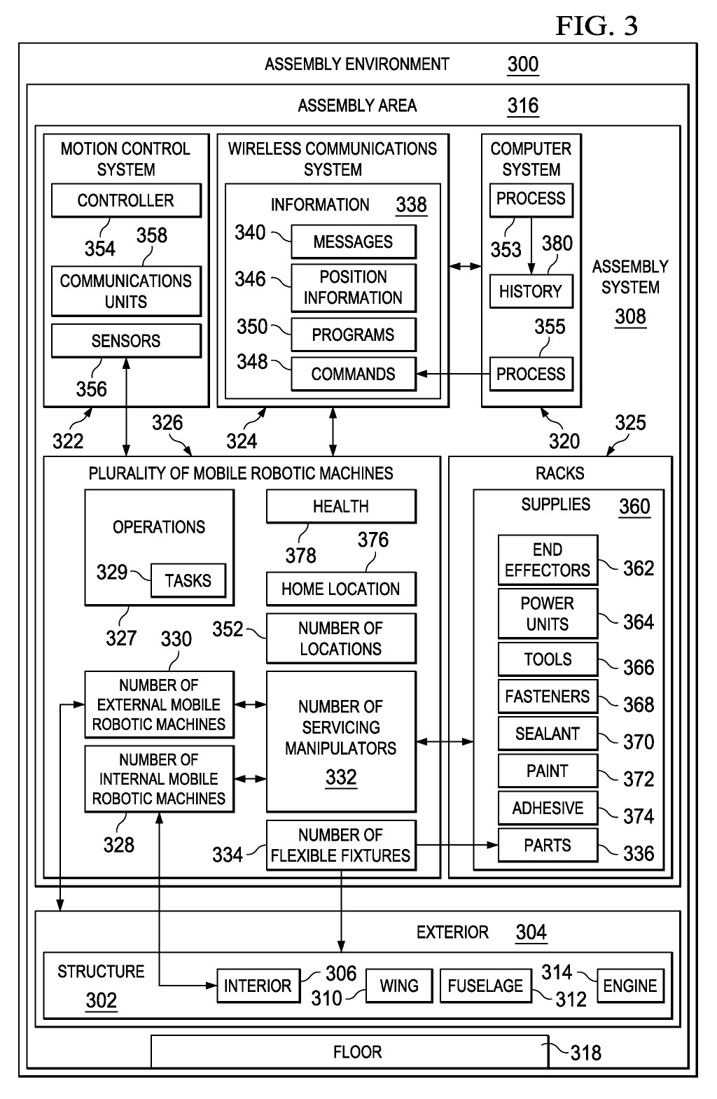

With reference now to FIG. 3, an illustration of an assembly environment is depicted in accordance with an advantageous embodiment. Assembly environment 300 is an example of an assembly environment that may be used to assemble structure 302. Structure 302 may have exterior 304 and interior 306.

In this illustrative example, assembly environment 300 may include assembly system 308. In the different illustrative examples, assembly system 308 may be an autonomous assembly system that may reconfigure itself to perform assembly of different types of structures in a manner faster than currently available assembly systems.

Structure 302 may be a structure for an object such as, for example, aircraft 200 in FIG. 2. Structure 302 may take various forms. For example, without limitation, structure 302 may be wing 310, fuselage 312, engine 314, and/or some other suitable type of structure.

In this illustrative example, structure 302 may be assembled in assembly area 316. Assembly area 316 may include floor 318. In this illustrative example, floor 318 may not require specialized fixed structures, trenches, underground conduits, and/or other infrastructures that may be used in currently available assembly environments.

Assembly system 308 may include computer system 320, motion control system 322, wireless communications system 324, plurality of mobile robotic machines 326, racks 325, and/or other suitable components.

In these illustrative examples, plurality of mobile robotic machines 326 may perform operations 327 to assemble structure 302. In these illustrative examples, plurality of mobile robotic machines 326 may include, for example, without limitation, number of internal mobile robotic machines 328, number of external mobile robotic machines 330, number of servicing manipulators 332, number of flexible fixtures 334, and/or other suitable types of mobile robotic machines.

Number of internal mobile robotic machines 328 may be capable of performing operations 327 in interior 306 of structure 302. Number of internal mobile robotic machines 328 may move into interior 306 and/or reach into interior 306 of structure 302 to perform operations 327. Number of external mobile robotic machines 330 may perform operations 327 on exterior 304 of structure 302. In these illustrative examples, one or more of operations 327 may be grouped together to form a task within tasks 329.

Number of servicing manipulators 332 may provide supplies to various robotic machines, such as number of internal mobile robotic machines 328 and number of external mobile robotic machines 330. Number of flexible fixtures 334 may be capable of holding structure 302 and/or parts 336 for structure 302. Parts 336 may be objects and/or materials used to assemble structure 302. Number of flexible fixtures 334 also may be capable of positioning and/or moving structure 302. For example, number of flexible fixtures 334 may be capable of moving and/or positioning structure 302 within assembly area 316 during assembly of structure 302.

Further, number of flexible fixtures 334 may be capable of moving structure 302 out of assembly area 316 after assembly of structure 302 has been completed. Parts 336 may include, for example, without limitation, a panel, a frame, a rib, a spar, an engine casing, and/or some other suitable type of part.

In the illustrative examples, operations 327 may be, for example, without limitation, clamping, drilling, fastening, sealing, painting, sanding, routing, milling, inspecting, measuring, and/or other suitable types of operations.

Wireless communications system 324 may be used to exchange information 338 between plurality of mobile robotic machines 326 and/or computer system 320. Information 338 may be exchanged between different machines within plurality of mobile robotic machines 326 as well as between computer system 320 and plurality of mobile robotic machines 326. Information 338 may include, for example, without limitation, messages 340, position information 346, commands 348, programs 350, and/or other suitable types of information.

Messages 340 may be, for example, without limitation, status messages, requests, alerts, errors, and/or other suitable types of messages. Position information 346 may provide a position for one or more of plurality of mobile robotic machines 326 within assembly area 316. For example, plurality of mobile robotic machines 326 may be located in number of locations 352. These locations, as well as positions of various portions of plurality of mobile robotic machines 326, may form position information 346.

Commands 348 may be issued by process 355 executed on computer system 320 and/or other machines within plurality of mobile robotic machines 326. Programs 350 may contain computer readable instructions in a functional form that can be executed by plurality of mobile robotic machines 326 to perform operations 327.

Programs 350 may be sent before and/or during execution of operations 327. For example, if a particular mobile robotic machine in plurality of mobile robotic machines 326 completes a task, a new program in programs 350 may be sent to that robotic machine to cause the robotic machine to perform a new task.

Motion control system 322 may provide position information 346 for communication between plurality of mobile robotic machines 326 and/or computer system 320 over wireless communications system 324. Motion control system 322 may include controller 354, sensors 356, communications units 358, and/or other suitable components.

Sensors 356 may collect information about the position of plurality of mobile robotic machines 326, parts 336, and/or other suitable objects. Communications units 358 may receive information from sensors 356 and/or request position information 346 from sensors 356.

Position information 346 may be used to avoid collisions of plurality of mobile robotic machines 326 with each other and/or other objects within assembly area 316. Further, position information 346 may be used to coordinate performing operations 327 between plurality of mobile robotic machines 326. Communications units 358 may include, for example, without limitation, transmitters, receivers, transceivers, and/or other suitable types of communication devices.

Controller 354 may distribute position information 346 over wireless communications system 324. Sensors 356 may include, for example, without limitation, a camera, a global positioning system unit, a radio frequency identifier, and/or some other suitable type of sensor. Sensors 356 may be located on plurality of mobile robotic machines 326, on floor 318 in assembly area 316, and/or at other locations suitable for use in generating position information 346.

In assembling structure 302, racks 325 may provide supplies 360. Supplies 360 may include, for example, without limitation, parts 336, end effectors 362, power units 364, tools 366, fasteners 368, sealant 370, paint 372, adhesive 374, and/or other suitable materials.

Further, racks 325 may be mobile and may move to and/or around number of locations 352 to provide supplies to plurality of mobile robotic machines 326. In some advantageous embodiments, number of servicing manipulators 332 may obtain supplies 360 from racks 325 and transport supplies 360 to plurality of mobile robotic machines 326.

With assembly system 308, plurality of mobile robotic machines 326 may move from home location 376 to number of locations 352 to perform operations 327 to assemble structure 302. In the different advantageous embodiments, plurality of mobile robotic machines 326 may move and change locations within number of locations 352 during the performance of operations 327.

Further, in some advantageous embodiments, structure 302 may remain stationary during the performance of operations 327. In yet other advantageous embodiments, number of flexible fixtures 334 may reposition and/or move structure 302 within assembly area 316 during the performance of operations 327. This movement may be similar to that in fixed assembly systems currently used.

When operations 327 are completed, plurality of mobile robotic machines 326, racks 325, and other mobile objects in assembly system 308 may move to home location 376. This movement may leave floor 318 clear and ready for other types of operations.

Further, with assembly system 308, increased flexibility may be present in manufacturing different types of structures as compared to currently available manufacturing systems. For example, plurality of mobile robotic machines 326 may switch from assembling structure 302 in the form of wing 310 to fuselage 312 or to engine 314 by receiving new programs from programs 350 from computer system 320.

Also, the assembly of a particular type of structure may be facilitated by the selection of needed supplies from supplies 360 on racks 325. With programs 350 for a particular type of structure, number of locations 352 may change. Plurality of mobile robotic machines 326 may provide a capability to move to different locations within number of locations 352 needed for different types of structures.

This movement may not require rerouting of power lines, conduits, trenches, rails, and/or other suitable types of cables. Further, de-attaching and reattaching robotic machines in new locations also may be avoided. As a result, less time may be needed to change assembly system 308 from one type of structure to another. Making changes to assemble different types of structures may be performed with less time and cost as compared to currently available systems.

Also, assembly system 308 may be used to assemble other types of structures other than those for aircraft. With a change in programs 350 and/or supplies 360, assembly system 308 may be used to assemble structures for other objects such as, for example, without limitation, cars, submarines, ships, tanks, and/or other suitable objects.

Computer system 320 also may monitor the health of various components in assembly system 308. For example, computer system 320 may monitor health 378 for plurality of mobile robotic machines 326. The level and/or amount of supplies 360 on racks 325 also may be monitored by computer system 320.

When portions of plurality of mobile robotic machines 326 become worn out, those portions may be changed during the performance of operations 327. These changes may be performed using number of servicing manipulators 332. In this manner, the time to exchange worn out portions of plurality of mobile robotic machines 326 or to replace supplies 360 used by plurality of mobile robotic machines 326 may be reduced.

Further, process 353 executing on computer system 320 may create history 380 for the assembly of structure 302. History 380 may be analyzed to identify improvements and/or changes needed for future assembly operations.

In performing assembly of structure 302, computer system 320 may transmit programs 350 to plurality of mobile robotic machines 326. Plurality of mobile robotic machines 326 may move from home location 376 to number of locations 352. Racks 325 may be positioned within appropriate locations in number of locations 352.

Thereafter, operations 327 may begin to perform assembly of structure 302. After assembly of structure 302 has been completed, plurality of mobile robotic machines 326 may return to home location 376.

At that time, assembly area 316 may be ready for the assembly of another structure. The new structure may be the same type as structure 302 or a different type of structure. Further, the assembly of the next structure may be performed using plurality of mobile robotic machines 326 or another group of mobile robotic machines.

The illustration of assembly environment 300 in FIG. 3 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, number of servicing manipulators 332 may be unnecessary. With this type of embodiment, plurality of mobile robotic machines 326 may return to racks 325 to obtain supplies 360.

Further, in some advantageous embodiments, an additional structure, in addition to structure 302, may be assembled within assembly area 316 by plurality of mobile robotic machines 326. Plurality of mobile robotic machines 326 may move from location to location within number of locations 352 to perform assembly of both structures concurrently. Further, a particular mobile robotic machine within plurality of mobile robotic machines 326 may perform more than one task.

As one task is completed in assembly of structure 302, a mobile robotic machine may receive a new program to perform another task needed to complete assembly of structure 302. Also, in some advantageous embodiments, having both internal mobile robotic machines and external mobile robotic machines may be unnecessary. In some advantageous embodiments, a mobile robotic machine may perform both types of functions and may switch functions during the assembly of structure 302.

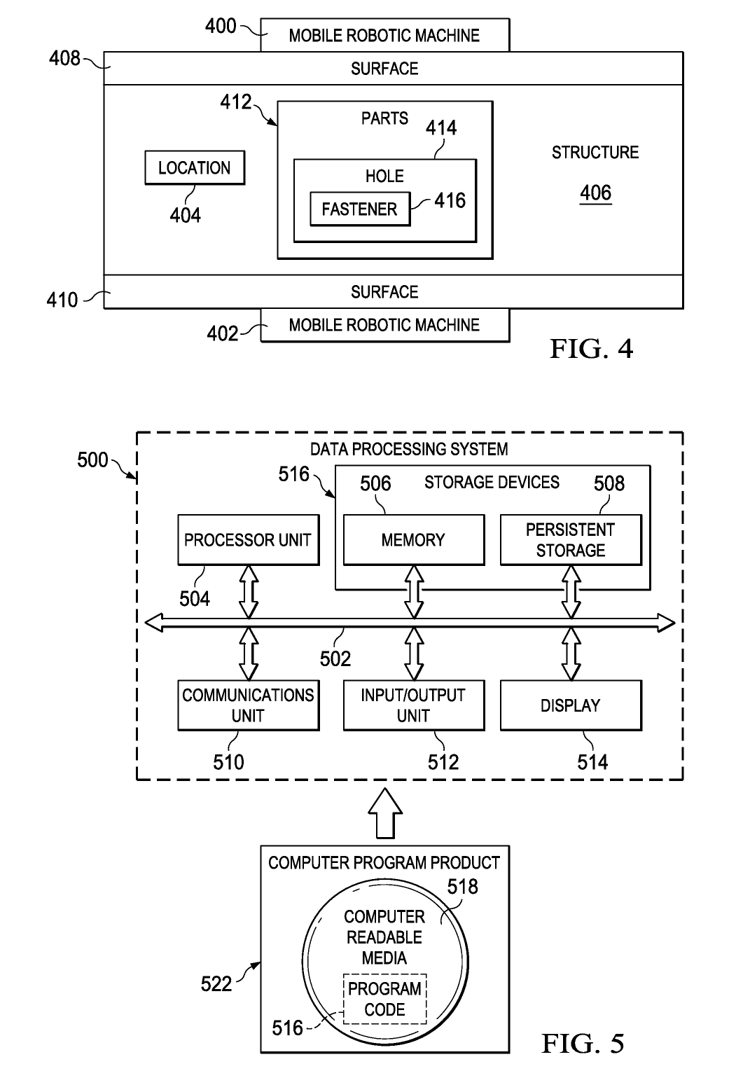

Turning now to FIG. 4, an illustration of an assembly process is depicted in accordance with an advantageous embodiment. In this depicted example, mobile robotic machine 400 and mobile robotic machine 402 may be part of plurality of mobile robotic machines 326 in FIG. 3 performing operations 327 on a structure.

In this illustrative example, mobile robotic machine 400 and mobile robotic machine 402 may move to location 404 on structure 406. Structure 406 may be one example of a structure such as, for example, without limitation, structure 302 in FIG. 3. In this illustrative example, mobile robotic machine 400 may be located on surface 408 of structure 406, and mobile robotic machine 402 may be located on surface 410 of structure 406.

Mobile robotic machine 400 and mobile robotic machine 402 may perform clamping operations to clamp parts 412 to each other. Mobile robotic machine 400 may perform a drilling operation to drill hole 414 through parts 412. Thereafter, mobile robotic machine 400 and mobile robotic machine 402 may install fastener 416 in hole 414 to secure parts 412 to each other. Mobile robotic machine 400 and mobile robotic machine 402 may then cease the clamping operation and move to another location to perform additional operations.

Turning now to FIG. 5, an illustration of a data processing system is depicted in accordance with an advantageous embodiment. In this illustrative example, data processing system 500 includes communications fabric 502, which provides communications between processor unit 504, memory 506, persistent storage 508, communications unit 510, input/output (I/O) unit 512, and display 514. Data processing system 500 may be used in computer system 320, motion control system 322, wireless communications system 324, and within plurality of mobile robotic machines 326. Depending on the particular implementation, different architectures and/or configurations of data processing system 500 may be used.

Processor unit 504 serves to execute instructions for software that may be loaded into memory 506. Processor unit 504 may be a set of one or more processors or may be a multi-processor core, depending on the particular implementation. Further, processor unit 504 may be implemented using one or more heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device may be any piece of hardware that may be capable of storing information such as, for example, without limitation, data, program code in functional form, and/or other suitable information either on a temporary basis and/or a permanent basis. Memory 506, in these examples, may be, for example, a random access memory or any other suitable volatile or non-volatile storage device.

Persistent storage 508 may take various forms depending on the particular implementation. For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 may be a network interface card. Communications unit 510 may provide communications through the use of either or both physical and wireless communications links.

Input/output unit 512 allows for input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer-implemented instructions, which may be located in a memory, such as memory 506.

These instructions are referred to as program code, computer usable program code, or computer readable program code that may be read and executed by a processor in processor unit 504. The program code in the different embodiments may be embodied on different physical or tangible computer readable media, such as memory 506 or persistent storage 508.

Program code 516 may be located in a functional form on computer readable media 518 that may be selectively removable and may be loaded onto or transferred to data processing system 500 for execution by processor unit 504. Program code 516 and computer readable media 518 form computer program product 522 in these examples. In one example, computer readable media 518 may be in a tangible form such as, for example, an optical or magnetic disk that may be inserted or placed into a drive or other device that may be part of persistent storage 508 for transfer onto a storage device, such as a hard drive that may be part of persistent storage 508.

In a tangible form, computer readable media 518 also may take the form of a persistent storage, such as a hard drive, a thumb drive, or a flash memory that may be connected to data processing system 500. The tangible form of computer readable media 518 may also be referred to as computer recordable storage media. In some instances, computer readable media 518 may not be removable.

Alternatively, program code 516 may be transferred to data processing system 500 from computer readable media 518 through a communications link to communications unit 510 and/or through a connection to input/output unit 512. The communications link and/or the connection may be physical or wireless in the illustrative examples. The computer readable media also may take the form of non-tangible media, such as communications links or wireless transmissions containing the program code.

In some illustrative embodiments, program code 516 may be downloaded over a network to persistent storage 508 from another device or data processing system for use within data processing system 500. For instance, program code stored in a computer readable storage medium in a server data processing system may be downloaded over a network from the server to data processing system 500. The data processing system providing program code 516 may be a server computer, a client computer, or some other device capable of storing and transmitting program code 516.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500.

Other components shown in FIG. 5 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 500 may be any hardware apparatus that may store data. Memory 506, persistent storage 508, and computer readable media 518 are examples of storage devices in a tangible form.

In another example, a bus system may be used to implement communications fabric 502 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 506 or a cache such as found in an interface and memory controller hub that may be present in communications fabric 502.

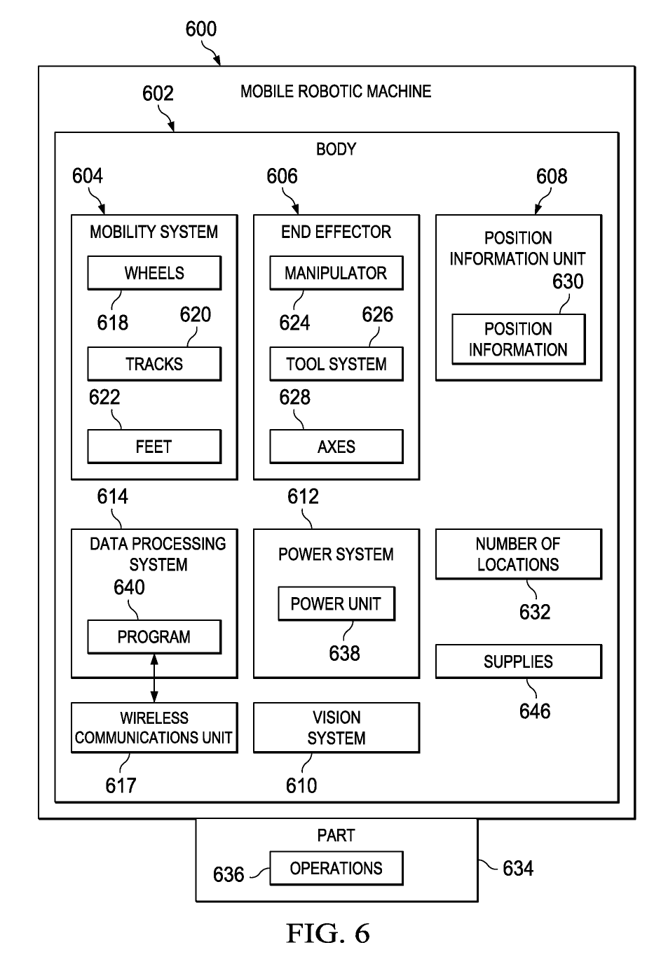

Turning now to FIG. 6, an illustration of a mobile robotic machine is depicted in accordance with an advantageous embodiment. Mobile robotic machine 600 is an example of one manner in which plurality of mobile robotic machines 326 in FIG. 3 may be implemented. Mobile robotic machine 600 may be autonomous and may perform operations without requiring continuous instructions from different sources.

As illustrated, mobile robotic machine 600 may include body 602, mobility system 604, end effector 606, position information unit 608, vision system 610, power system 612, data processing system 614, and other suitable components.

Body 602 may provide a structure and/or housing for which different components may be located on and/or in mobile robotic machine 600. Mobility system 604 may provide mobility for mobile robotic machine 600.

Mobility system 604 may take various forms. Mobility system 604 may include, for example, without limitation, wheels 618, tracks 620, feet 622, and/or other suitable components. End effector 606 may be a component that provides mobile robotic machine 600 a capability to perform operations. End effector 606 may be manipulator 624 and/or tool system 626. Manipulator 624 may hold and/or manipulate tool system 626.

Tool system 626 may be a number of tools. For example, tool system 626 may include, without limitation, a drill, a fastener device, a sealing device, and/or some other suitable type of tool. In these illustrative examples, end effector 606 may be moved about three or more of axes 628.

Position information unit 608 may be capable of generating position information 630 for number of locations 632 for mobile robotic machine 600. For example, without limitation, number of locations 632 may be a location for body 602, end effector 606, and/or some other suitable location on mobile robotic machine 600. Position information 630 may be in a three-dimensional space using three or more of axes 628. Vision system 610 may include, for example, without limitation, a camera, a data processing system, and/or software capable of identifying objects, positions of objects, and/or other information needed to perform operations on a part.

Vision system 610 may provide mobile robotic machine 600 a capability to view part 634 and operations 636 being performed on part 634. Power system 612 may provide power to operate mobile robotic machine 600. Power system 612 may generate power using power unit 638. Power unit 638 may be removable and/or replaceable. Power unit 638 may be changed when power unit 638 becomes depleted.

Power unit 638 may be, for example, without limitation, a battery and/or some other suitable type of power unit. For example, power unit 638 may be a wireless transfer unit capable of receiving power without using wires. In these illustrative examples, data processing system 614 may receive and store program 640.

Data processing system 614 may control the operation of mobile robotic machine 600 by executing program 640 in these examples. Program 640 may be received through wireless communications unit 617 and/or some other source. In these illustrative examples, wireless communications unit 617 may provide the capability to transfer information, such as position information 530, between mobile robotic machine 600 and other components within assembly environment 300 in FIG. 3.

In these illustrative examples, mobile robotic machine 600 may reconfigure itself to perform various operations within operations 636. This reconfiguration may be performed by receiving a new version of program 640 and supplies 646. Supplies 646 may include, for example, without limitation, end effectors, tools, parts, and/or other suitable components needed to perform operations 636.

Further, in executing program 640, mobile robotic machine 600 may be capable of determining what parts of tool system 626, manipulator 624, and/or other components in mobile robotic machine 600 may begin to wear out and require replacement. Program 640 may provide mobile robotic machine 600 a capability to request supplies 646 as needed. Further, program 640 also may provide mobile robotic machine 600 a capability to request service and/or maintenance. Further, if mobile robotic machine 600 is unable to perform certain operations within operations 636, mobile robotic machine 600 may send a request to another mobile robotic machine to perform those operations.

Mobile robotic machine 600 may provide a capability to move to different locations without requiring cables, fixed attachments, rails, and/or other components currently used by robotic machines in assembly systems.

The illustration of mobile robotic machine 600 in FIG. 6 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, position information unit 608 may be unnecessary. Position information unit 608 may be unnecessary if the motion control system uses only cameras to identify position information. In yet other advantageous embodiments, mobile robotic machine 600 may include an additional end effector in addition to end effector 606.

Mobile robotic machine 600 is an example of a machine that may be used to implement one or more of plurality of mobile robotic machines 326 in FIG. 3. For example, mobile robotic machine 600 may be used to implement an external mobile robotic machine, a servicing manipulator, a flexible fixture, an internal mobile robotic machine, and/or some other suitable type of mobile robotic machine.

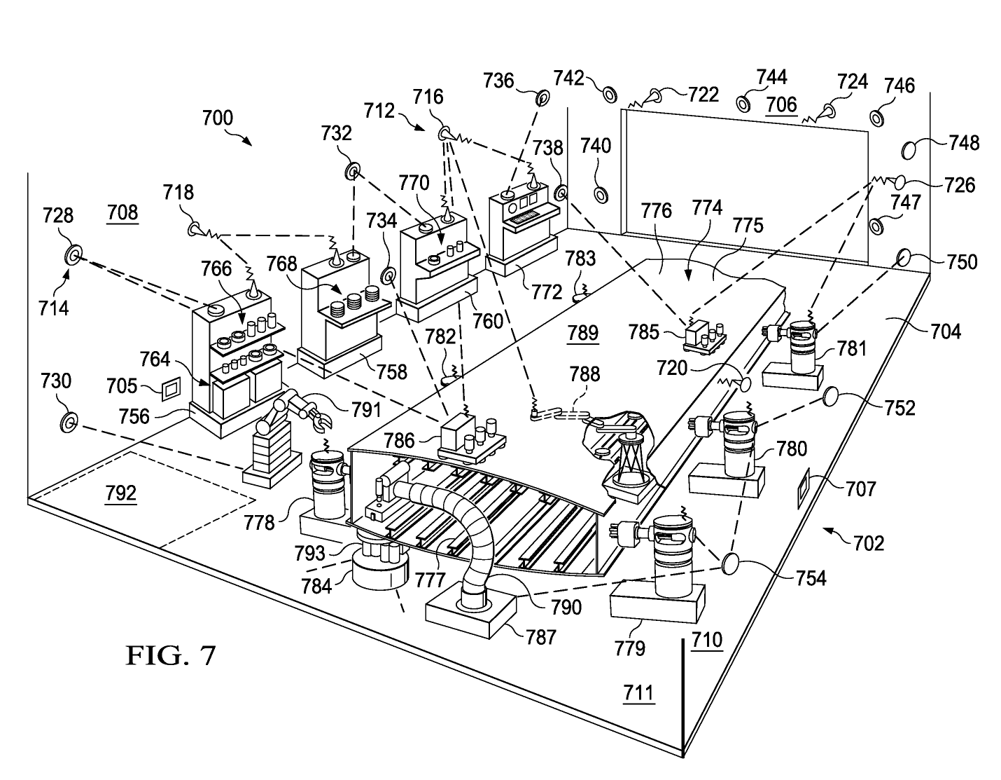

Turning now to FIG. 7, an illustration of an assembly environment is depicted in accordance with an advantageous embodiment. In this illustrative example, assembly environment 700 is an example of one implementation for assembly environment 300 in FIG. 3. In this example, assembly area 702 in assembly environment 700 may include floor 704, wall 706, wall 708, wall 710, and wall 711. In this illustrative example, wall 710 and wall 711 may be shown in an exposed view.

In this view, components for wireless communications system 712 and motion control system 714 may be seen attached to walls 706, 708, and 710. Wireless communications system 712 may have wireless communications units 716, 718, 720, 722, 724, and 726. These wireless communications units may be receivers, transmitters, transceivers, and/or some other suitable type of wireless communications units.

Motion control system 714 may include motion control units 728, 730, 732, 734, 736, 738, 740, 742, 744, 746, 747, 748, 750, 752, and 754. These motion control units may be, for example, without limitation, receivers, cameras, radio frequency identification readers, and/or other suitable components that may be capable of being used to generate position information.

In this illustrative example, racks 756, 758, and 760 may be located against wall 708. Supplies such as, for example, batteries 764, tools 766, cassettes 768, and effectors 770 may be supplied by these racks. System controller 772 is an example of a computer system that may be used to control the assembly of structure 774 in these examples.

Structure 774 may be wing 775. Wing 775 may have exterior 776 and interior 777. Flexible fixtures 778, 779, 780, 781, 782, and 783 may hold wing 775 to perform operations to assemble wing 775.

The assembly of wing 775, in these examples, may be performed using external mobile robotic machines 784, 785, and 786, which perform operations on exterior 776 of wing 775. The assembly of wing 775 also may be performed using internal mobile robotic machines 787 and 788, which may perform operations on interior 777 of wing 775. In this illustrative example, external robotic machines 785 and 786 move on surface 789 of wing 775 to perform operations.

In this depicted example, internal mobile robotic machine 787 may have flexible arm 790, which may allow internal mobile robotic machine 787 to reach into interior 777 of wing 775 to perform operations. Additionally, servicing manipulator 791 may provide supplies and/or maintenance for the different mobile robotic machines performing operations to assemble wing 775.

Additionally, utility outlets 705 and 707 may be present on walls 708 and 710, respectively. Utility outlets 705 and 707 may provide connections to utilities such as, for example, electricity, water, air, and/or other suitable utilities. Utility outlets 705 and 707 may be used during assembly operations and/or for maintenance after assembly operations have been completed.

Home location 792 may be a location in which the different mobile robotic machines may be located prior to beginning assembly operations. Home location 792 also may be a location that the mobile robotic machines may return to after completing operations.

Different mobile robotic machines may work in conjunction with each other to perform operations. For example, internal mobile robotic machine 787 may work in conjunction with external robotic machine 784 to perform various operations, such as drilling and/or fastener installation.

For example, external robotic machine 784 may have electromagnet 793 and may clamp portions of wing 775 to perform various operations in conjunction with internal mobile robotic machine 787. Other mobile robotic machines may work independently such as, for example, external mobile robotic machine 785, external mobile robotic machine 786, and internal mobile robotic machine 788.

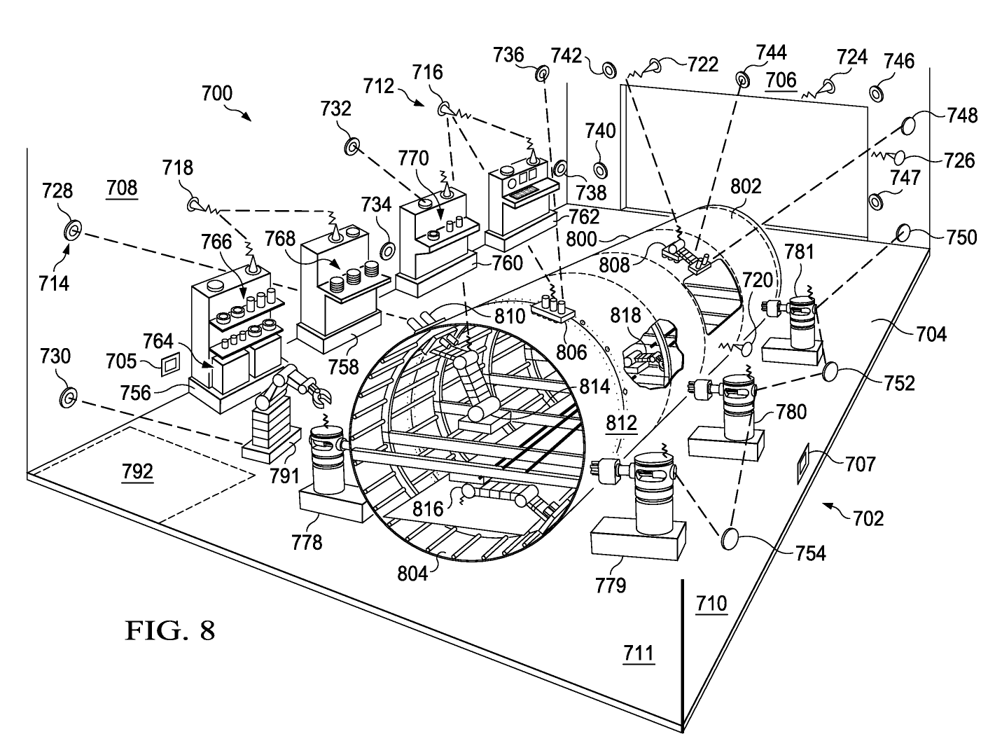

Turning now to FIG. 8, an illustration of an assembly environment is depicted in accordance with an advantageous embodiment. In this illustrative example, assembly environment 700 may be reconfigured for use in performing operations to assemble fuselage 800. Fuselage 800 may have exterior 802 and interior 804.

With this type of structure, external mobile robotic machines 806, 808, and 810 may perform operations on surface 812 of exterior 802 of fuselage 800. Internal mobile robotic machines 814, 816, and 818 may perform operations on interior 804 of fuselage 800.

The illustration of assembly environment 700 in FIG. 7 and FIG. 8 is only an illustrative example of one manner in which an assembly environment can be implemented to assemble a structure. Assembly environment 700 may provide increased flexibility in one or more of the different advantageous embodiments to assemble different types of structures. Assembly area 702 may be used to manufacture different types of structures, such as wing 775 and fuselage 800.

The reconfiguration of assembly environment 700 may be performed quickly by changing the programs for mobile robotic machines, adding mobile robotic machines, removing mobile robotic machines, or other suitable configuration changes. These changes may be made more quickly and/or with less expense as compared to changes needed to reconfigure current assembly systems.

For example, if wing 775 may be assembled before fuselage 800, the mobile robotic machines used to assemble wing 775 may be reprogrammed and/or replaced as needed with other mobile robotic machines to assemble fuselage 800 in assembly area 702. These changes may be performed without requiring the time and/or expense needed to make changes to currently available assembly systems. Rerouting of wires, rails, trenches, and other components may be unnecessary with this type of assembly system.

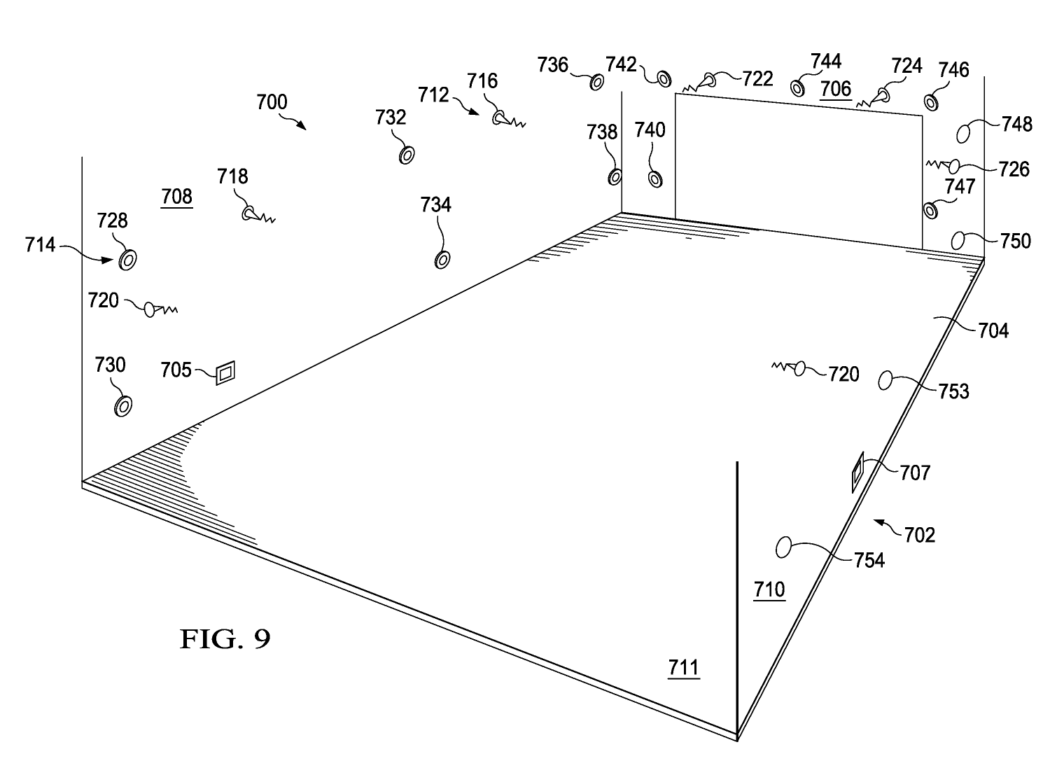

With reference now to FIG. 9, an illustration of an assembly area is depicted in accordance with an advantageous embodiment. In this illustrative example, assembly area 702 is illustrated without the different racks and/or mobile robotic machines. Assembly area 702 is an illustration of an area when no operations are being performed to assemble structures. A lack of fixed robotic machines, rails, trenches, conduits, cables, and other structures may allow for easy reconfiguration of assembly area 702 for other operations. Further, the lack of fixed structures also may allow for easier maintenance of assembly area 702.

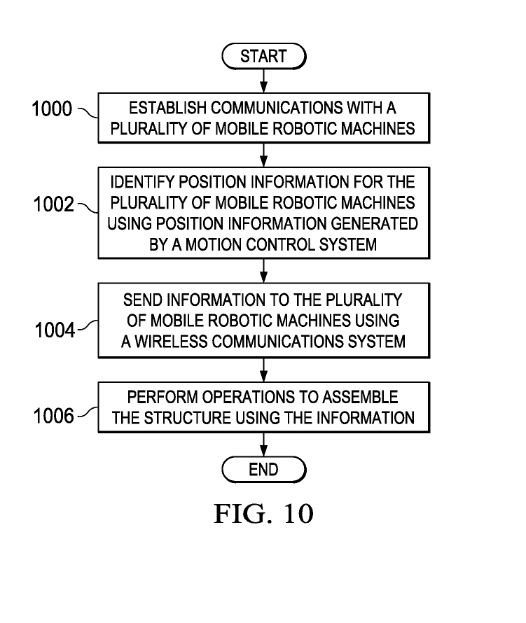

Turning now to FIG. 10, an illustration of a flowchart of a process for assembling a structure is depicted in accordance with an advantageous embodiment. The process illustrated in FIG. 10 may be implemented in assembly environment 300 in FIG. 3.

The process may begin by establishing communications with plurality of mobile robotic machines 326 (operation 1000). Plurality of mobile robotic machines 326 may be capable of moving to number of locations 352 and performing operations 327 to assemble structure 302 in assembly area 316 using wireless communications system 324.

Position information 346 for plurality of mobile robotic machines 326 may be identified using position information 346 generated by motion control system 322 (operation 1002). Position information 346 may be positions of plurality of mobile robotic machines 326 and/or different parts of plurality of mobile robotic machines 326. Information 338 may be sent to plurality of mobile robotic machines 326 using wireless communications system 324 (operation 1004). Information 338 may include position information. Operations 327 may be performed to assemble structure 302 using information 338 (operation 1006), with the process terminating thereafter.

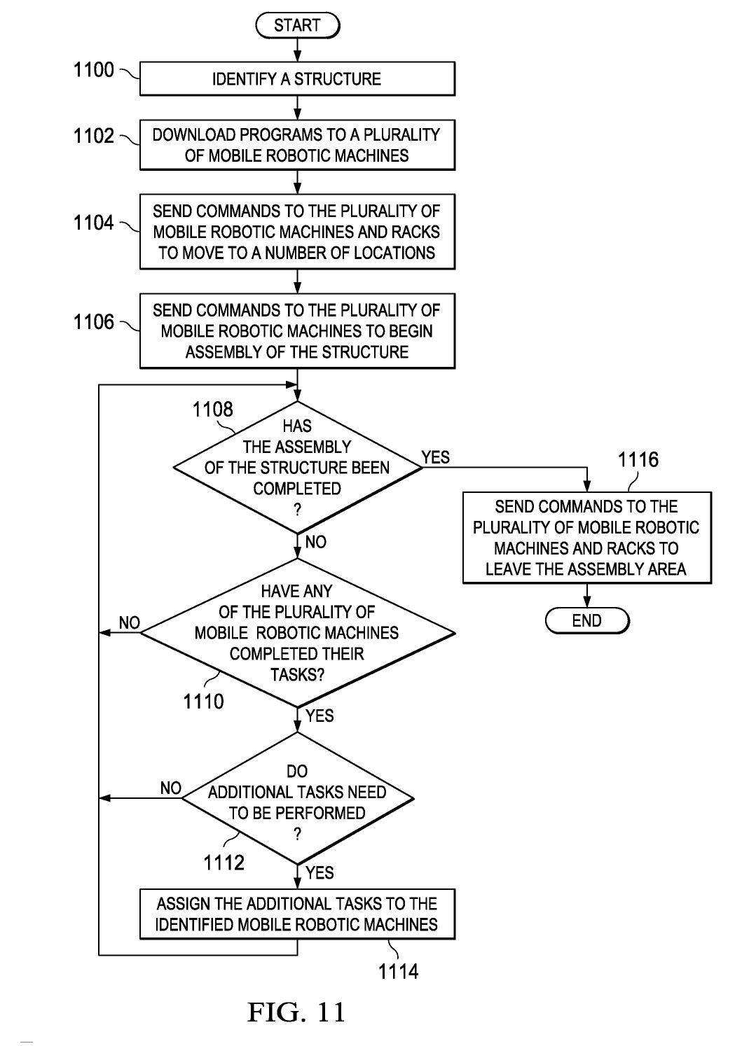

With reference now to FIG. 11, an illustration of a flowchart of a process for assembling a structure is depicted in accordance with an advantageous embodiment. The process illustrated in FIG. 11 may be implemented in assembly environment 300 in FIG. 3. For example, the process may be implemented in process 355 in computer system 320 to control the assembly of structure 302 in FIG. 3.

The process may begin by identifying structure 302 (operation 1100). Thereafter, the process may download programs 350 to plurality of mobile robotic machines 326 (operation 1102). The process may then send commands 348 to plurality of mobile robotic machines 326 and racks 325 to move to number of locations 352 (operation 1104). The process may then send commands 348 to plurality of mobile robotic machines 326 to begin assembly of structure 302 (operation 1106).

A determination may be made as to whether the assembly of structure 302 has been completed (operation 1108). If the assembly of structure 302 has not been completed, a determination may be made as to whether any of plurality of mobile robotic machines 326 have completed their tasks (operation 1110). These tasks may be tasks within tasks 329.

If any of plurality of mobile robotic machines 326 have completed their tasks, a determination may be made as to whether additional tasks need to be performed (operation 1112). In some examples, some mobile robotic machines may complete tasks before other mobile robotic machines. In these examples, these mobile robotic machines may perform other tasks that may shorten the time needed to assemble structure 302. Mobile robotic machines that may not have tasks may be assigned tasks that may aid other mobile robotic machines to complete their tasks more quickly. Further, if one mobile robotic machines needs maintenance or service, another mobile robotic machine that has completed its tasks may perform tasks for the mobile robotic machine needing maintenance or service.

If additional tasks need to be performed, the process may assign the additional tasks to the identified mobile robotic machines (operation 1114). In operation 1114, commands 348 and/or programs 350 may be sent to the identified mobile robotic machines. The process may then return to operation 1108. With reference again to operation 1112, if additional tasks do not need to be performed, the process may return to operation 1108. The process also may return to operation 1108 from operation 1110 if none of plurality of mobile robotic machines 326 have completed their tasks.

With reference again to operation 1108, if the assembly of structure 302 has been completed, the process then may send commands 348 to plurality of mobile robotic machines 326 and racks 325 to leave assembly area 316 (operation 1116), with the process terminating thereafter. In operation 1116, some of plurality of mobile robotic machines 326 may return to home location 376. Number of flexible fixtures 334 within plurality of mobile robotic machines 326 may move structure 302 to another area for further processing and/or storage.

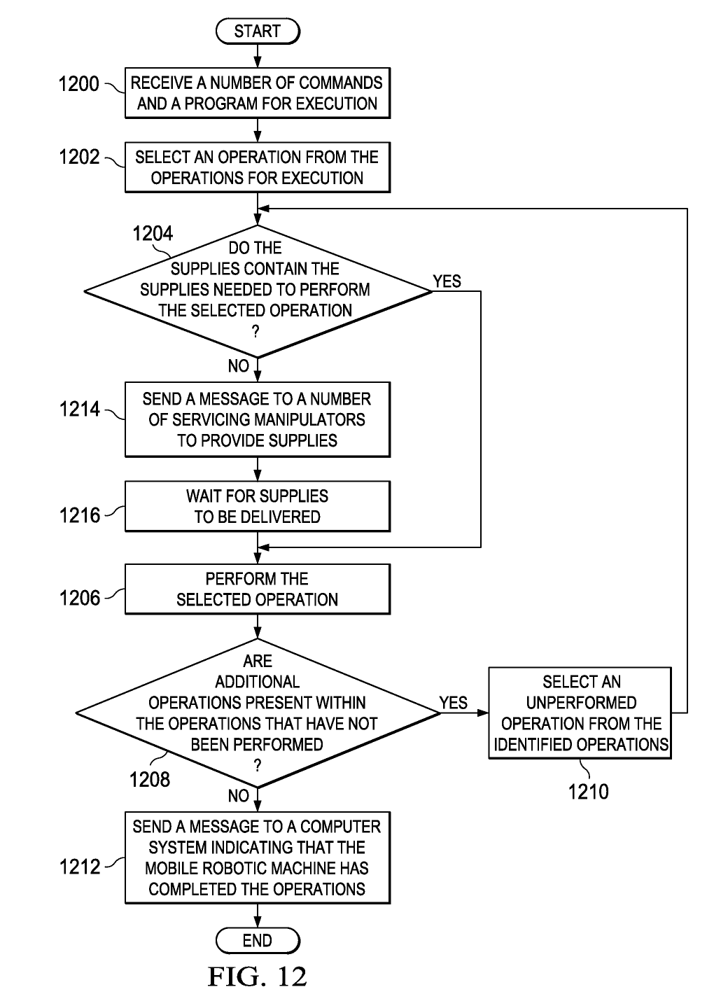

Turning next to FIG. 12, an illustration of a flowchart of a process for assembling a structure is depicted in accordance with an advantageous embodiment. In this illustrative example, the process in FIG. 12 may be implemented in a mobile robotic machine, such as mobile robotic machine 600 in FIG. 6. This process may be implemented by data processing system 614 in FIG. 6.

The process may begin by receiving a number of commands and a program for execution (operation 1200). The process may then select an operation from operations 636 for execution (operation 1202). A determination may be made as to whether supplies 646 contain supplies needed to perform the selected operation (operation 1204).

If supplies are present, the process may perform the selected operation (operation 1206). This operation may be, for example, without limitation, drilling a hole, clamping a part in coordination with another mobile robotic machine, milling a part, applying sealant, performing an inspection of a part, and/or other suitable operations.

After the operation has been performed, a determination may be made as to whether additional operations are present within operations 636 that have not been performed (operation 1208). If additional operations are present, the process may select an unperformed operation from the identified operations (operation 1210), with the process then returning to operation 1204.

If all of the operations have been completed, the process may send a message to a computer system indicating that mobile robotic machine 600 has completed operations 636 (operation 1212), with the process terminating thereafter. At this point, mobile robotic machine 600 may wait for additional commands.

With reference again to operation 1204, if supplies 646 do not contain supplies needed to perform the identified operation, the process may then send a message to number of servicing manipulators 332 to provide supplies 646 (operation 1214). The process may then wait for supplies 646 to be delivered (operation 1216). When supplies 646 have been delivered, the process may then proceed to operation 1206 as described above. These supplies may include, for example, without limitation, fasteners, end effectors, tools, power units, and/or other suitable supplies.

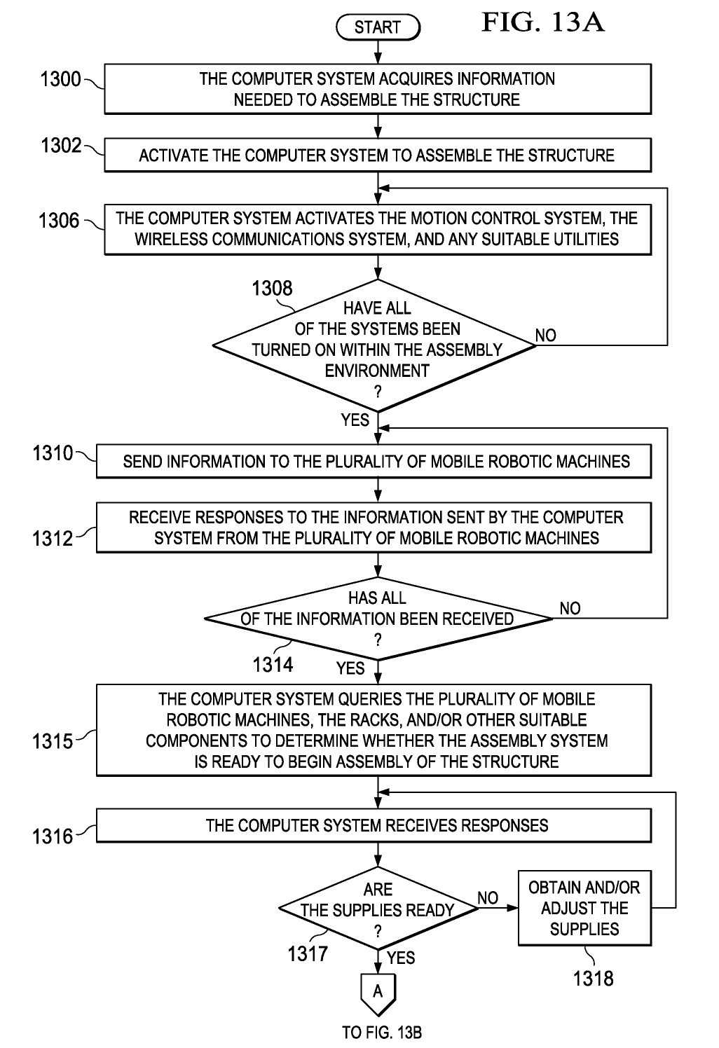

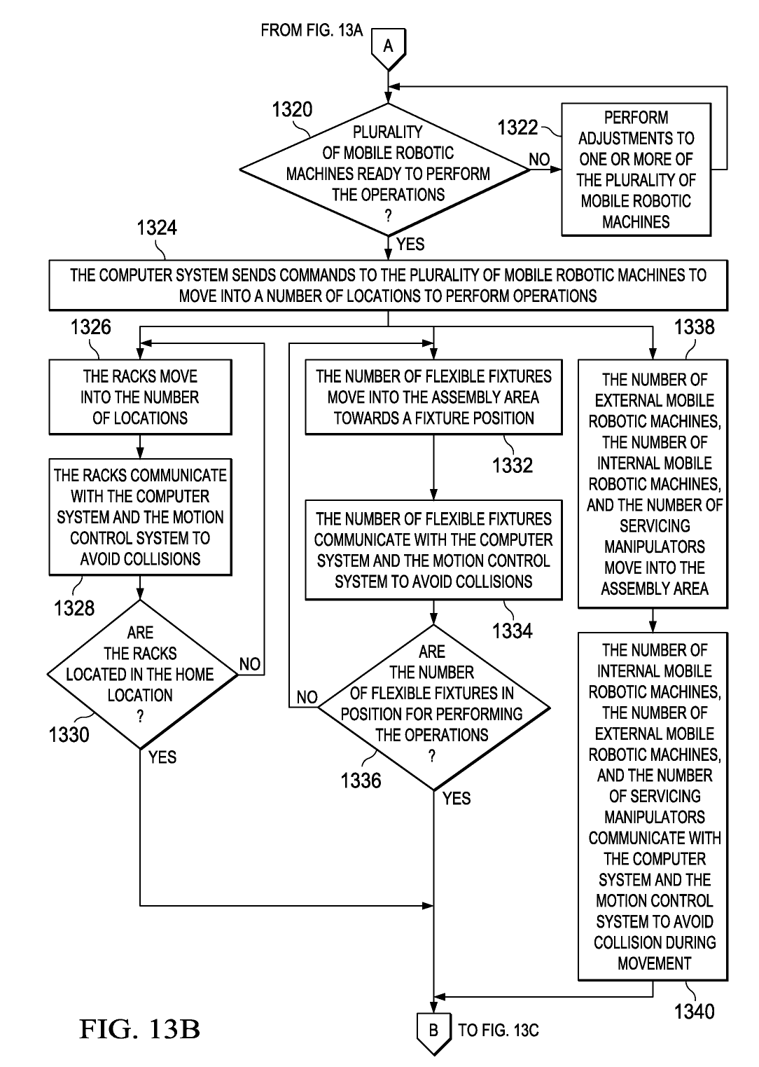

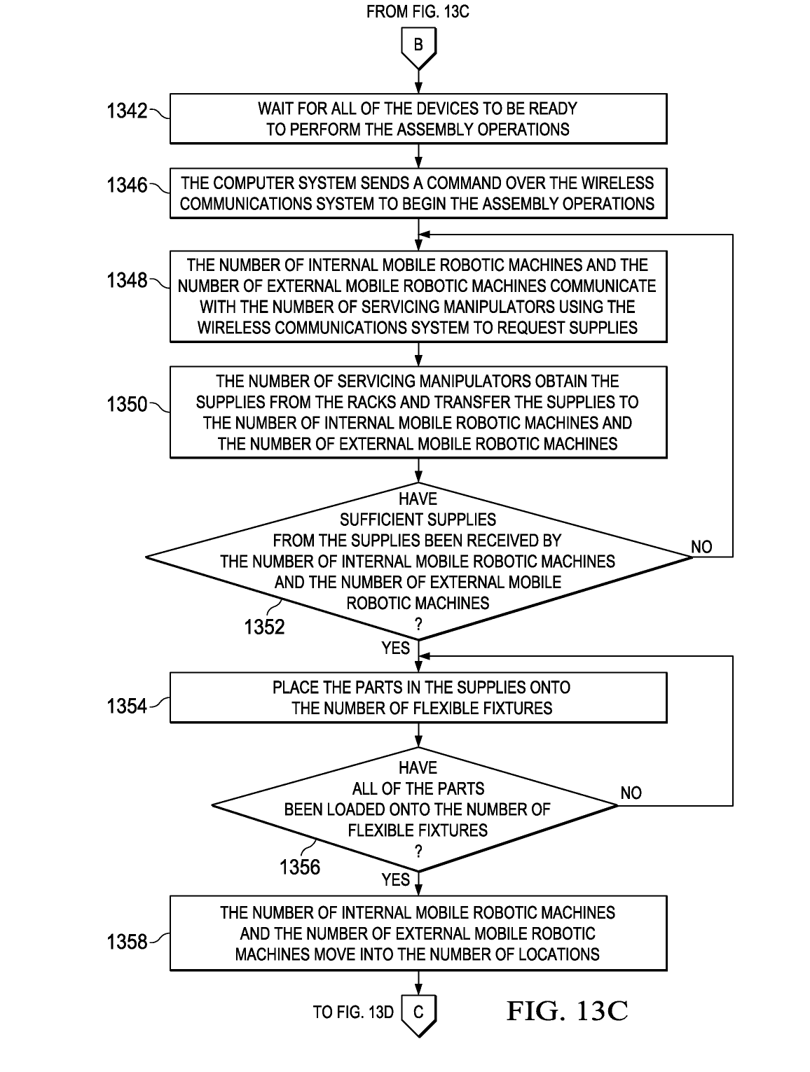

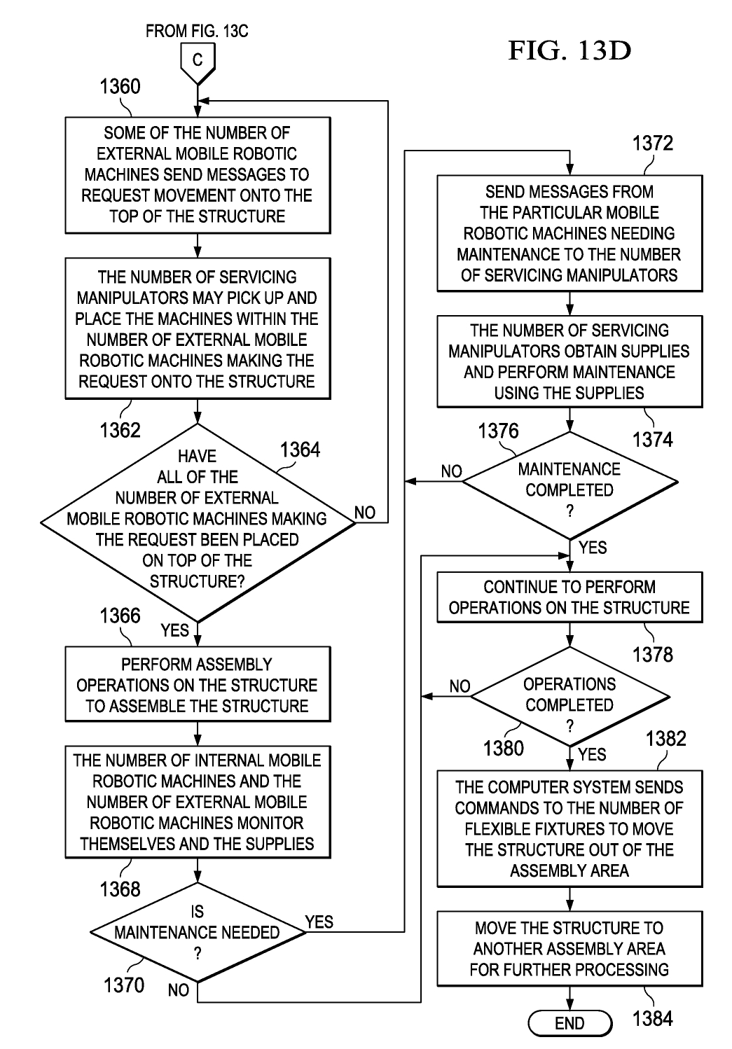

With reference now to FIGS. 13A-13D, an illustration of a flowchart of a process for assembling an aircraft structure is depicted in accordance with an advantageous embodiment. The process illustrated in FIGS. 13A-13D are an example of one manner in which operations may be performed to assemble an aircraft structure. The process illustrated in FIGS. 13A-13D may be implemented using assembly environment 300 in FIG. 3.

The process may begin with computer system 320 acquiring information needed to assemble structure 302 (operation 1300). This information may include, for example, without limitation, specifications, manufacturing plans, needed equipment, needed tools, needed parts, needed materials, and/or other suitable information. The process may then activate computer system 320 to assemble structure 302 (operation 1302). Computer system 320 may activate motion control system 322, wireless communications system 324, and any suitable utilities (operation 1306). A determination may be made as to whether all of the systems have been turned on within assembly environment 300 (operation 1308). If all of the systems have not been turned on, the process may return to operation 1306.

If all the systems in operation 1308 have been turned on, computer system 320 may send information 338 to plurality of mobile robotic machines 326 (operation 1310). Information 338 may include, for example, without limitation, messages 340, position information 346, commands 348, programs 350, and/or other suitable information needed to perform operations 327 to assemble structure 302.

Responses to the information sent by computer system 320 may be received from plurality of mobile robotic machines 326 (operation 1312). A determination may be made as to whether all of information 338 has been received (operation 1314). If all of information 338 has not been received, the process returns to operation 1310.

When all of information 338 has been received, computer system 320 queries plurality of mobile robotic machines 326, racks 325, and/or other suitable components to determine whether assembly system 308 is ready to begin assembly of structure 302 (operation 1315).

Computer system 320 may receive responses (operation 1316) and may determine whether supplies 360 are ready (operation 1317). If supplies 360 are not ready, supplies 360 are obtained and/or adjusted (operation 1318). Operation 1318 may include calibrating and loading tools, end effectors, fastener cassettes, batteries, and/or other suitable supplies. The process then may return to operation 1316.

If supplies 360 are ready, the process may determine whether plurality of mobile robotic machines 326 is ready to perform operations 327 (operation 1320).

If all of plurality of mobile robotic machines 326 are not ready to perform operations 327, adjustments to one or more of plurality of mobile robotic machines 326 may be performed (operation 1322), with the process then returning to operation 1320.

Operation 1322 may include, for example, without limitation, calibrating and/or setting up number of internal mobile robotic machines 328, number of external mobile robotic machines 330, number of servicing manipulators 332, number of flexible fixtures 334, and/or other suitable machines. When all of plurality of mobile robotic machines 326 are ready, computer system 320 may send commands 348 to plurality of mobile robotic machines 326 to move into number of locations 352 to perform operations 327 (operation 1324).

In response to receiving commands 348, racks 325 may move into number of locations 352 (operation 1326). Racks 325 may communicate with computer system 320 and motion control system 322 to avoid collisions (operation 1328). A determination may then be made as to whether racks 325 are located in home location 376 (operation 1330). If racks 325 are not in home location 376, the process may return to operation 1326.

In response to receiving commands 348 in operation 1324, number of flexible fixtures 334 may move into assembly area 316 towards a fixture position (operation 1332). Number of flexible fixtures 334 may communicate with computer system 320 and motion control system 322 to avoid collisions (operation 1334). A determination may then be made as to whether number of flexible fixtures 334 are in position for performing operations 327 (operation 1336). If number of flexible fixtures 334 are not in position, the process may return to operation 1332.

Also, in response to commands 348 in operation 1324, number of external mobile robotic machines 330, number of internal mobile robotic machines 328, and number of servicing manipulators 332 may move into assembly area 316 (operation 1338). Number of internal mobile robotic machines 328, number of external mobile robotic machines 330, and number of servicing manipulators 332 may communicate with computer system 320 and motion control system 322 to avoid collision during movement (operation 1340).

In operations 1330, 1336, and 1340, the process may wait for all of the devices to be ready to perform operations 327 (operation 1342). When all of the devices are ready to perform operations 327, computer system 320 may send a command over wireless communications system 324 to begin assembly operations 327 (operation 1346). Assembly operations may be a subset of operations 327 and may involve positioning and securing parts to each other to form structure 302.

Number of internal mobile robotic machines 328 and number of external mobile robotic machines 330 may communicate with number of servicing manipulators 332 using wireless communications system 324 to request supplies 360 (operation 1348). Number of servicing manipulators 332 may obtain supplies 360 from racks 325 and transfer supplies 360 to number of internal mobile robotic machines 328 and number of external mobile robotic machines 330 (operation 1350).

A determination may be made as to whether sufficient supplies from supplies 360 have been received by number of internal mobile robotic machines 328 and number of external mobile robotic machines 330 (operation 1352). If sufficient supplies from supplies 360 have not been received, the process may return to operation 1348. These supplies may include parts, fasteners, sealant, paint, adhesive, and/or other suitable supplies needed to assemble structure 302. Once sufficient supplies have been received, parts in supplies 360 may be placed onto number of flexible fixtures 334 (operation 1354).

A determination may then be made as to whether all of the parts have been loaded onto number of flexible fixtures 334 (operation 1356). If all of the parts have not been loaded, the process may return to operation 1354. Otherwise, number of internal mobile robotic machines 328 and number of external mobile robotic machines 330 may move into number of locations 352 (operation 1358).

Some of number of external mobile robotic machines 330 may send messages 340 to request movement onto the top of structure 302 (operation 1360). Number of servicing manipulators 332 may pick up and place the machines within number of external mobile robotic machines 330 making the request onto structure 302 (operation 1362).

A determination may be made as to whether all of number of external mobile robotic machines 330 making the request have been placed on top of structure 302 (operation 1364). If all of number of external mobile robotic machines 330 making the request have not been placed on top of structure 302, the process may return to operation 1360.

Otherwise, the process may then perform assembly operations 327 on structure 302 to assemble structure 302 (operation 1366). These assembly operations may include synchronized assembly operations between number of internal mobile robotic machines 328 and number of external mobile robotic machines 330. Number of internal mobile robotic machines 328 and number of external mobile robotic machines 330 monitor themselves and supplies 360 (operation 1368).

A determination may be made as to whether maintenance is needed (operation 1370). The maintenance may require replacements of end effectors 362, power units 364, tools 366, fasteners 368, and/or other suitable forms of supplies 360.

If maintenance operations are needed, messages 340 may be sent from the particular mobile robotic machines needing maintenance to number of servicing manipulators 332 (operation 1372). In response to receiving messages 340, number of servicing manipulators 332 may obtain supplies 360 and perform maintenance using supplies 360 (operation 1374).

A determination may be made as to whether maintenance has been completed (operation 1376). If maintenance has not been completed, the process may return to operation 1372. If maintenance operations are complete, the process may continue to perform operations 327 on structure 302 (operation 1378). Operations 327 may include assembly of parts, inspections, and other suitable operations needed to assemble structure 302. Thereafter, a determination may be made as to whether operations 327 have been completed (operation 1380).

If operations 327 have not been completed, the process may return to operation 1378. When operations 327 have been completed, computer system 320 may send commands 348 to number of flexible fixtures 334 to move structure 302 out of assembly area 316 (operation 1382). Thereafter, structure 302 may be moved to another assembly area for further processing (operation 1384), with the process then terminating.

With reference again to operation 1370, if maintenance is not needed, the process continues to operation 1378 as described above.

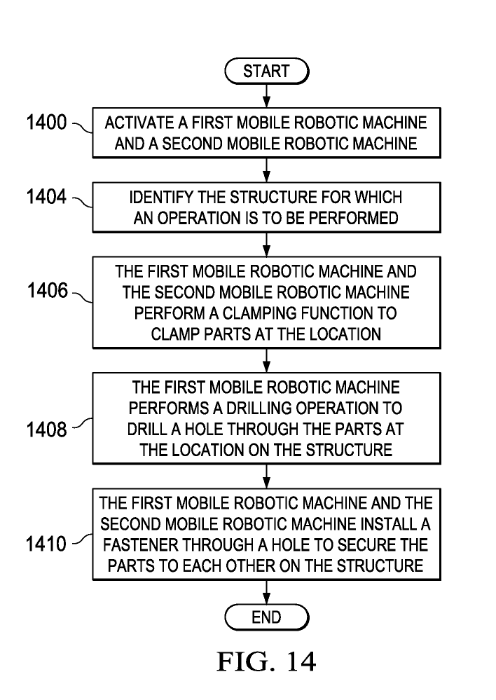

Turning now to FIG. 14, an illustration of a flowchart of a process for performing operations on a structure is depicted in accordance with an advantageous embodiment. The process illustrated in FIG. 14 may be implemented in an environment such as, for example, assembly environment 300 in FIG. 3.

The process may begin by activating a first mobile robotic machine and a second mobile robotic machine (operation 1400). Thereafter, structure 302 may be identified for which an operation is to be performed (operation 1404). The first mobile robotic machine may be adjacent to a first surface of structure 302, while the second mobile robotic machine may be adjacent to a second surface of structure 302.

The first mobile robotic machine and the second mobile robotic machine may perform a clamping function to clamp parts at the location (operation 1406). The first mobile robotic machine may perform a drilling operation to drill a hole through the parts at the location on structure 302 (operation 1408). The first mobile robotic machine and the second mobile robotic machine may install a fastener through a hole to secure the parts to each other on structure 302 (operation 1410), with the process terminating thereafter.

The flowcharts and block diagrams in the different depicted embodiments illustrate the architecture, functionality, and operation of some possible implementations of apparatus and methods in different advantageous embodiments. In this regard, each block in the flowcharts or block diagrams may represent a module, segment, function, and/or a portion of an operation or step.

In some alternative implementations, the function or functions noted in the blocks may occur out of the order noted in the figures. For example, in some cases, two blocks shown in succession may be executed substantially concurrently, or the blocks may sometimes be executed in the reverse order, depending upon the functionality involved.

Thus, the different advantageous embodiments provide a method and apparatus for assembling structures in a manner that may provide increased flexibility to the different types of structures that may be assembled within a particular assembly area. The different advantageous embodiments may provide a capability to alter the type of structure being assembled in a manner that may be faster and/or less expensive as compared to current assembly systems. The different advantageous embodiments may avoid a need for fixed rails, fixed robotic machines, trenches, conduits in the floor, and other structures that may require time and expense to move and/or modify.

The description of the different advantageous embodiments has been presented for purposes of illustration and description, and it is not intended to be exhaustive or limited to the embodiments in the form disclosed. Many modifications and variations will be apparent to those of ordinary skill in the art. Further, different advantageous embodiments may provide different advantages as compared to other advantageous embodiments.

Although the different advantageous embodiments have been described with respect to structures of an aircraft, other advantageous embodiments may be applied to other types of objects. For example, without limitation, other advantageous embodiments may be applied to a wing, a fuselage, an engine, a tank, a submarine hull, a spacecraft, a space station, a surface ship, and a car.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a plurality of mobile robotic machines capable of moving to a number of locations in an assembly area and capable of performing operations to assemble a structure in the assembly area;
a wireless communications system capable of providing communications with the plurality of mobile robotic machines within the assembly area; and
a motion control system capable of generating position information for the plurality of mobile robotic machines in the assembly area and communicating the position information to the plurality of mobile robotic machines.

2. The apparatus of claim 1 further comprising:
a number of racks capable of carrying supplies for the plurality of mobile robotic machines.

3. The apparatus of claim 1, wherein the plurality of mobile robotic machines comprises at least one of an internal mobile robotic machine, an external mobile robotic machine, a flexible fixture, and a servicing machine.

4. The apparatus of claim 1, wherein the position information comprises at least one of a position of an arm on a mobile robotic machine, a position of an end effector on the mobile robotic machine, a position of a body of the mobile robotic machine, and a position of a part.

5. The apparatus of claim 1, further comprising:
a computer system, wherein the computer system is capable of exchanging information with the plurality of mobile robotic machines.

6. The apparatus of claim 5, wherein the information comprises at least one of a command, data, a position of a mobile robotic machine, and a program capable of being executed by the mobile robotic machine in the plurality of mobile robotic machines.

7. The apparatus of claim 2, wherein the supplies comprise at least one of a power unit, an end effector, a tool, and a part.

8. The apparatus of claim 1, wherein the wireless communications system comprises:
a number of wireless ports located in the assembly area, wherein each of the plurality of mobile robotic machines have a communications unit capable of establishing a communications link with the number of wireless ports.

9. The apparatus of claim 1, wherein the motion control system comprises:
a plurality of sensors; and
a computer capable of identifying positions of the plurality of mobile robotic machines using the plurality of sensors.

10. The apparatus of claim 9, wherein the plurality of sensors comprises a number of types of sensors selected from at least one of a camera, a receiver capable of receiving global positioning system information from the plurality of mobile robotic machines, and a radio frequency identification sensor reader.

11. The apparatus of claim 9, wherein the plurality of sensors are located on at least one of the plurality of mobile robotic machines and at selected locations in the assembly area.

12. The apparatus of claim 1, wherein the plurality of mobile robotic machines comprises:
an external mobile robotic machine capable of moving around an exterior of the structure and capable of performing a number of first operations on the exterior of the structure; and
an internal mobile robotic machine capable of performing a number of second operations in an interior of the structure and capable of performing the number of second operations in conjunction with the number of first operations performed by the external mobile robotic machine to assemble the structure.

13. The apparatus of claim 1, wherein the operations comprise at least one of fastening parts, inspecting parts, drilling holes, clamping parts, installing fasteners, and applying sealant.

14. The apparatus of claim 1, wherein the structure is selected from one of an aircraft, a wing, a fuselage, an engine, a tank, a submarine hull, a spacecraft, a space station, a surface ship, and a car.

15. An assembly system comprising:
an external mobile robotic machine capable of moving around an exterior of a structure and capable of performing a number of first operations on the exterior of the structure; and
an internal mobile robotic machine capable of performing a number of second operations in an interior of the structure and capable of performing the number of second operations in conjunction with the number of first operations performed by the external mobile robotic machine to assemble the structure.

16. The assembly system of claim 15, wherein the internal mobile robotic machine is capable of moving in the interior of the structure to perform the number of second operations.

17. The assembly system of claim 15, wherein the internal mobile robotic machine is capable of moving a number of members into the interior of the structure to perform the number of second operations.

18. An aircraft assembly system comprising:
a plurality of mobile robotic machines capable of moving to a number of locations in an assembly area and capable of performing operations to assemble a structure for an aircraft in the assembly area, wherein the plurality of mobile robotic machines comprises at least one of an internal mobile robotic machine, an external mobile robotic machine, a flexible fixture, and a servicing machine, wherein the external mobile robotic machine is capable of moving around an exterior of the structure and capable of performing a number of first operations on the exterior of the structure, and the internal mobile robotic machine is capable of performing a number of second operations in an interior of the structure and capable of performing the number of second operations in conjunction with the number of first operations performed by the external mobile robotic machine;
a number of racks capable of carrying supplies for the plurality of mobile robotic machines, wherein the supplies comprise at least one of a power unit, an end effector, a tool, and a part;
a wireless communications system capable of providing communications with the plurality of mobile robotic machines within the assembly area, wherein the wireless communications system comprises a number of wireless ports located in the assembly area, and wherein each of the plurality of mobile robotic machines has a communications unit capable of establishing a communications link with the number of wireless ports;
a motion control system capable of generating position information for the plurality of mobile robotic machines in the assembly area and communicating the position information to the plurality of mobile robotic machines, wherein the motion control system comprises a plurality of sensors and a computer capable of identifying positions of the plurality of mobile robotic machines using the plurality of sensors, wherein the plurality of sensors comprises a number of types of sensors selected from at least one of a camera, a receiver capable of receiving global positioning system information from the plurality of mobile robotic machines, and a radio frequency identification sensor reader, wherein the plurality of sensors is located on at least one of the plurality of mobile robotic machines and at selected locations in the assembly area, and wherein the position information comprises at least one of a position for an arm on a mobile robotic machine, a position of an end effector on the mobile robotic machine, a position of a body of the mobile robotic machine, and a position of a part; and
a computer system, wherein the computer system is capable of exchanging information with the plurality of mobile robotic machines, wherein the information comprises at least one of a command, data, position of a mobile robotic machine, and a program capable of being executed by a mobile robotic machine in the plurality of mobile robotic machines.

19. A method for assembling a structure, the method comprising:
establishing communications with a plurality of mobile robotic machines capable of moving to a number of locations in an assembly area and capable of performing operations to assemble the structure in the assembly area using a wireless communications system;
identifying position information for the plurality of mobile robotic machines using a motion control system;
sending information to the plurality of mobile robotic machines, wherein the information comprises the position information; and
performing the operations to assemble the structure using the position information.

20. The method of claim 19, wherein the step of sending the information to the plurality of mobile robotic machines comprises:
sending a number of programs to the plurality of mobile robotic machines.

21. The method of claim 19, wherein the step of sending the information to the plurality of mobile robotic machines comprises:
sending the position information to a number of the plurality of mobile robotic machines.

22. The method of claim 19, wherein the information further comprises at least one of messages, commands, and programs.

23. The method of claim 19, wherein the step of performing the operations to assemble the structure using the position information comprises:
communicating messages between the plurality of mobile robotic machines; and
performing a number of operations to assemble the structure using the messages.

24. A method for assembling an aircraft structure, the method comprising:
establishing communications with a plurality of mobile robotic machines capable of moving to a number of locations in an assembly area and capable of performing operations to assemble the aircraft structure in the assembly area using a wireless communications system;
identifying position information for the plurality of mobile robotic machines using a motion control system;
sending information to the plurality of mobile robotic machines, wherein the information comprises at least one of the position information and a number of programs and commands;
communicating messages between the plurality of mobile robotic machines; and
performing the operations to assemble the aircraft structure using the information and the messages.
